(19) United States
(12) Patent Application Publication
(10) Pub. No.: US 2020/0398754 A1
(43) Pub. Date: Dec. 24, 2020

(54) APPARATUS AND METHOD FOR DISPLAYING SIDE AND REAR IMAGES OF VEHICLE

(71) Applicant: GARIN SYSTEM Co., Ltd., Incheon (KR)

(72) Inventors: Yun Sub Lee, Incheon (KR); Chul Woo Lee, Incheon (KR)

(73) Assignee: GARIN SYSTEM Co., Ltd., Incheon (KR)

(21) Appl. No.: 16/586,967

(22) Filed: Sep. 28, 2019

(30) Foreign Application Priority Data
Jun. 19, 2019 (KR) 10-2019-0073004

(51) Int. Cl. B60R 1/04

(52) U.S. Cl. CPC B60R 1/04; B60R 2300/802; B60R 2300/50; B60R 2300/105; B60R 2300/304; B60R 2300/804

(57) ABSTRACT

Provided is an apparatus and method for displaying side and rear images of a vehicle. The apparatus includes a network connection line connected to a communication network of a vehicle, and an Audio Video Navigation (AVN) connection line connected to the AVN. Here, as a certain event signal is broadcasted through the communication network of a vehicle, any one of one or more cameras is switched so as to be connected to the AVN, and a reverse gear signal is transmitted along a line directly connected to the AVN. The reverse gear signal is the same signal as a signal that is broadcasted through the communication network as a transmission becomes a reverse state.

### CROSS-REFERENCE TO RELATED APPLICATIONS

This U.S. non-provisional patent application claims priority under 35 U.S.C. § 119 of Korean Patent Application No. 10-2019-0073004, filed on Jun. 19, 2019, the entire contents of which are hereby incorporated by reference.

### BACKGROUND OF THE INVENTION

The present invention disclosed herein relates to an apparatus and method for displaying side and rear images of a vehicle, and more particularly, to an apparatus and method for displaying side and rear images of a vehicle, which is installed so as to be connected to a communication network and an Audio Video Navigation (AVN) of vehicle electric parts, monitors event signals generated during driving of a vehicle, and if a specific condition is satisfied, forcibly converts mode of the AVN to allow images of side and rear cameras to be displayed on the AVN.

Integrating vehicle's audio, video and navigation systems into a unit is commonly referred to as an Audio Video Navigation (AVN).

FIG. 1 is a view illustrating an interior of a vehicle equipped with a typical AVN. As shown in FIG. 1, the AVN is installed in a center fascia of a vehicle to visually display information when multimedia contents are played or navigation is executed.

FIG. 2 is a view illustrating a rear image display apparatus of a vehicle which displays a rear image of a vehicle using the AVN according to a related art.

As shown in FIG. 2, in the rear image display apparatus of a vehicle according to the related art, as the transmission 10 of a vehicle is set to reverse, an Electronic Control Unit (ECU) 20 broadcasts a signal informing that the gear state of a vehicle is the reverse through the CAN-BUS 50. Then, the AVN 40 connected to the CAN-BUS 50 switches the input source to the camera, and displays a rear image inputted from a camera 30 instead of the screen (e.g., a map image of a navigation device) that is being outputted.

On the contrary, as the transmission 10 changes to neutral, driving, or parking mode, the ECU 20 broadcasts a signal informing that the state of the transmission 10 is changed, and then the AVN 40 stops outputting the rear image inputted from the camera 30 and returns to the screen that is being previously outputted.

The above-described operation is a typical operation method of a vehicle in its original state. In general, vehicle electric parts operate in a very closed way for security reasons. Also, it is very difficult to extend the operation of a vehicle such that electronic parts can operate in other ways than a regular way.

For example, even when there is another need for a driver to show the side and rear images of a vehicle in addition to the reverse state, it is difficult to implement this function unless such a function is supported in the original state.

### PRIOR ART DOCUMENT

### Patent Document

Document 1. Korean Patent No. 10-1656028 (control apparatus for changing the screen and audio of AVN system according to vehicle mode)

### SUMMARY OF THE INVENTION

The present invention provides an apparatus and method for displaying side and rear images of a vehicle, which is installed so as to be connected to a communication network of vehicle electric parts, monitors event signals generated during driving of a vehicle, and if a specific event signal is received, controls side and rear images of a vehicle photographed by cameras to be displayed through an AVN.

In order to achieve the above object, an apparatus for displaying side and rear images of a vehicle according to an embodiment of the present invention is connected to a communication network of a vehicle, and has a separate line electrically connected to an Audio Video Navigation (AVN).

Meanwhile, as a certain event signal is broadcasted through a communication network of a vehicle, any one of one or more cameras is switched so as to be connected to the AVN, and transmits a reverse gear signal to the AVN along a line directly connected to the AVN.

In this case, the reverse gear signal is the same signal as a signal that an ECU broadcasts through the communication network as a transmission becomes a reverse state, and is not transmitted to the communication network of a vehicle, but is transmitted through only a separate line electrically connected to the AVN.

Embodiments of the present invention provide apparatuses for displaying side and rear images of a vehicle including: a network connection line connected to a communication network of a vehicle; and an Audio Video Navigation (AVN) connection line connected to the AVN, wherein as a certain event signal is broadcasted through the communication network of a vehicle, any one of one or more cameras is switched so as to be connected to the AVN, and a reverse gear signal is transmitted along a line directly connected to the AVN, the reverse gear signal being the same signal as a signal that is broadcasted through the communication network as a transmission becomes a reverse state.

Meanwhile, the present invention may be utilized such that a camera of a black box separately provided in a vehicle is connected to the AVN. In this case, various kinds of information transmitted from the black box may be parsed and processed to be overlaid the output image of the camera connected to the AVN.

In other embodiments of the present invention, methods for displaying side and rear images of a vehicle including: monitoring a communication network during driving of a vehicle to determine whether or not a preset event signal is broadcasted; switching any one of the one or more cameras so as to be connected to an Audio Video Navigation (AVN) when a preset event signal is sensed; and transmitting a reverse gear signal along a line directly connected to the AVN, wherein the reverse gear signal is the same signal as a signal that is broadcasted through the communication network as a transmission becomes a reverse state.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating an interior of a vehicle equipped with an AVN;

FIG. 2 is a view illustrating a connection relationship between vehicle electric parts according to a related art;

FIG. 3 is a view illustrating a configuration of a side and rear image display apparatus of a vehicle according to an embodiment of the present invention;

FIG. 4 is a view illustrating an operation of the side and rear image display apparatus of a vehicle of FIG. 3;

FIG. 5 is a view illustrating a rear image displayed on an AVN screen of the side and rear image display apparatus of FIG. 3;

FIG. 6 is a view illustrating warning information displayed on a left image of the side and rear image display apparatus of FIG. 3;

FIG. 7 is a view illustrating warning information displayed on a right image of the side and rear image display apparatus of FIG. 3;

FIG. 8 is a view illustrating a compressed output image of a side and rear image display apparatus of a vehicle of FIG. 3, which is displayed on a mobile terminal; and

FIG. 9 is a flowchart illustrating a side and rear image display method of a vehicle according to an embodiment of the present invention.

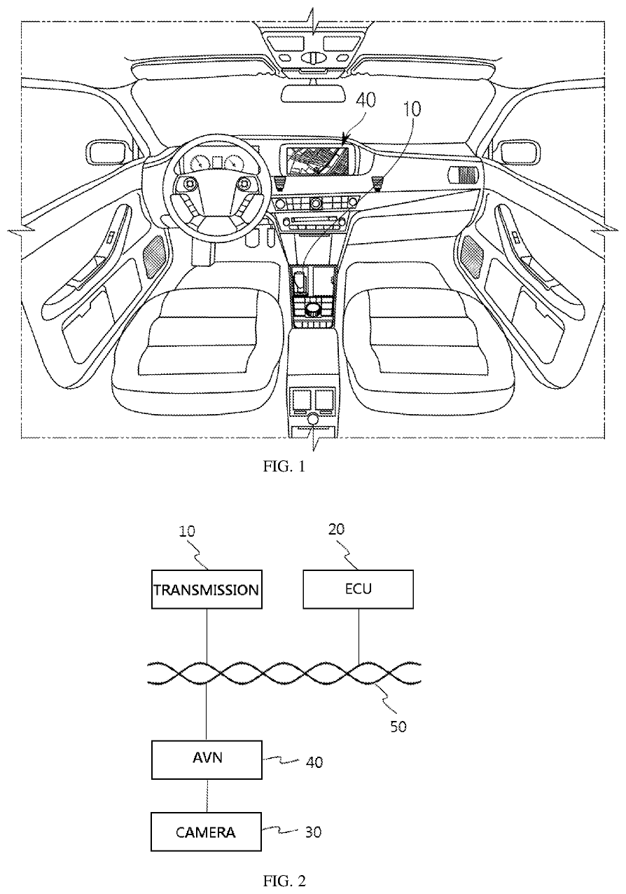

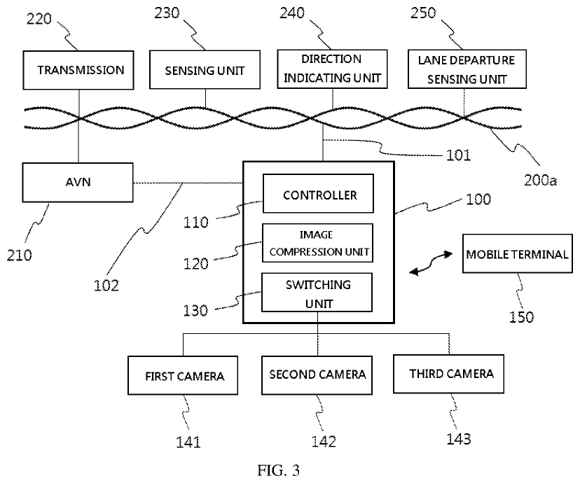

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a side and rear image display apparatus and method of a vehicle according to an embodiment of the present invention will be described with reference to specific embodiments.

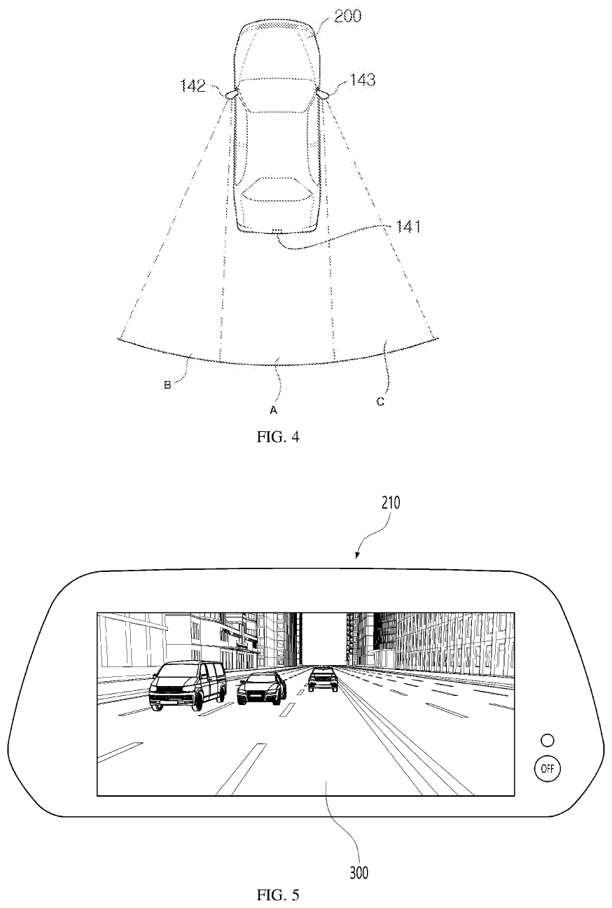

FIG. 3 is a view illustrating a configuration of a side and rear image display apparatus of a vehicle according to an embodiment of the present invention. FIG. 4 is a view illustrating an operation of the side and rear image display apparatus of a vehicle of FIG. 3.

As shown in FIGS. 3 and 4, the side and rear image display apparatus 100 of a vehicle according an embodiment of the present invention is connected to the communication network 200a of a vehicle 200 through a network connection line 101. When a specific event signal broadcasted through the communication network 200a is received, cameras 141, 142 and 143 are switched so as to be connected to an AVN 210 of a vehicle 200. Also, a reverse gear signal is outputted to the AVN 210 connected an AVN connection line 102 such that output images of the cameras 141, 142, and 143 can be displayed on the AVN 210. The side and rear image display apparatus 100 includes a controller 110, an image compression unit 120, and a switch unit 130.

The side and rear image display apparatus 100 of a vehicle may receive signals broadcasted by being connected to the communication network 200a of a vehicle 200 through a wiring work for connecting the network connection line 101 to the communication network 200a.

On the other hand, the side and rear image display apparatus 100 of a vehicle is electrically connected to the AVN 210 through a wiring work for directly connecting the AVN connection line 102 to the AVN 210. In this case, the AVN connection line 102 may be wired so as to be connected to a terminal connected to the communication network 200a of the AVN 210. By wiring in this manner, the AVN 210 cannot distinguish between the signal applied from the AVN connection line 102 and the signal broadcasted through the communication network 200a of a vehicle 200.

The side and rear image display apparatus 100 determines whether the event signal is an event signal inputted from any one of vehicle devices, for example, a sensing unit 230, a direction indicating unit 240, and a lane departure sensing unit 250.

Also, the side and rear image display apparatus 100 outputs a switching signal for connecting to at least one of the first to third cameras 141, 142 and 143 installed to photograph the surroundings of a vehicle using the determination result about the event signal.

Also, the side and rear image display apparatus 100 outputs a reverse gear signal (in this case, the reverse gear signal is the same as a broadcasted signal through the communication network as the transmission 220 becomes the reverse state) through the AVN connection line 102 directly connected to the AVN 210 such that images outputted from the connected camera among the first to third cameras 141, 142 and 143 can be displayed through the AVN 210.

The AVN 210 may output navigation information necessary for driving of a vehicle, images inputted from the rear camera, and safety convenience information together with the current state of a vehicle, and may be configured as a display means such as an LCD. Also, the AVN 210 may be configured as a well-known system. In this case, although the term AVN is used, it is not necessarily limited to a component called AVN. In addition, a digital cluster combined with the navigation or the AVN in cluster should also be interpreted as a broad AVN or equivalent.

Hereinafter, the image display device 100 according to an embodiment of the present invention will be described in more detail.

The controller 110 monitors the communication network 200a of a vehicle 200 connected through the network connection line 101 to monitor whether a preset event signal is transmitted.

The communication network 200a is configured with a Controller Area Network BUS 200a. In the present embodiment, the CAN-BUS is exemplified, but the communication network 200a is not limited thereto. The communication network 200a may include various vehicle communication networks such as Anything by Wire (‘X-by-Wire’), FlexRay, and LIN which is a vehicle LAN communication standard.

The event signal is a sensing target signal monitored by the controller 110, and may include a gear signal outputted from the transmission 220, a side sensing signal and a rear sensing signal outputted from the sensing unit 230, a direction indicating signal outputted from the direction indicating unit 240, and a lane departure sensing signal outputted from the lane departure sensing unit 250 which are transmitted through the communication network 200a of a vehicle.

In the present embodiment, for convenience of description, the event signal is described as the gear signal, side and rear sensing signals, direction indicating signal, and lane departure sensing signal, but the present invention is not limited thereto. It will be apparent to those skilled in the art that an input signal for outputting a photographed image of a camera installed in a vehicle using the AVN 210 during driving of a vehicle is added to the event signal.

The controller 110 performs a monitoring operation of the communication network 200a while the gear signal outputted from the transmission 220 is in the driving state (e.g., the gear box is in a state of “D”).

Also, when the controller 110 detects a specific event signal as a result of the monitoring, the controller 110 analyzes whether the detected event signal is a signal inputted from any of the left, right, and rear directions of a vehicle driving direction.

That is, when the event signal broadcasted through the communication network 200a is a sensing signal outputted from the sensing unit 230 including the rear sensor and the left/right sensors which sense an object approaching from the rear of a vehicle and an object approaching from the side of a vehicle, the controller 110 analyzes whether the sensing signal corresponds to any one of the rear region A, the left region B and the right region C of a vehicle.

Also, when the event signal monitored in the communication network 200a is a direction indicating signal inputted by a driver through the direction indicating unit 240, the controller 110 analyzes whether the sensing signal corresponds to any one of the left region B and the right region C of a vehicle.

Also, when the event signal monitored by the communication network 200a is the lane departure sensing signal outputted from the lane departure sensing unit 250, the controller 110 analyzes whether the sensing signal corresponds to any one of the left region B and the right region C of a vehicle.

Also, by using the result analyzed from the event signal, the controller 110 outputs a switching signal connecting such that the photographed image of the camera installed in the analyzed direction is outputted through the AVN 210.

That is, the controller 110 outputs, to the switching unit 130, a switching signal controlling such that at least one of the first camera 141 installed so as to photograph a rear region A at the trunk position of a vehicle 200, the second camera 142 installed so as to photograph a left region B at the left side mirror of a vehicle 200 and the third camera 143 installed so as to photograph a right region C at the right side mirror of a vehicle 200 are connected to the AVN 210.

Also, the controller 110 may output a switching signal such that an image outputted from one of the first to third cameras 141, 142 and 143 is inputted to the AVN 210, and may output the switching signal such that the photographed images outputted from the first camera 141 and the second camera 142 or the photographed images outputted from the first camera 141 and the third camera 143 are divided into a certain ratio and inputted to the AVN 210.

Also, since images outputted from outputted from the first to third cameras 141, 142 and 143 cannot be displayed through the AVN 210 when the gear signal outputted from the transmission 220 is “D”, the controller 110 outputs a reverse gear signal to the AVN 210 through the AVN connection line 102 directly connected to the AVN 210 such that the photographed images outputted from the connected first to third cameras 141, 142 and 143 can be displayed through the AVN 210.

In this case, the controller 110 generates a reverse gear signal and outputs the reverse gear signal directly to the AVN 210 through the AVN connection line 102 to deceive as if the transmission 220 outputs the reverse gear signal such that the AVN 210 can recognize that the transmission 220 has been changed to, for example, “R”.

More accurately, as the transmission 220 becomes reverse, a CAN packet broadcasted through the CAN-BUS is directly outputted to the AVN 210 through the AVN connection line 102.

When the reverse gear signal is applied by the controller 110, the AVN 210 recognizes that the reverse gear signal is broadcasted through the communication network 200a, and images inputted from the first to third cameras 141, 142 and 143 are displayed on the screen of the AVN 210.

FIG. 5 illustrates that a rear image of a vehicle is displayed through a screen of a navigation that displays map information, that is, an AVN 210 screen. For example, when the sensing unit 230 senses an object approaching from the rear side of a vehicle, the controller 110 outputs a switching signal such that the first camera 141 and the AVN 210 are connected, and outputs a reverse gear signal to the AVN 210 through the AVN connection line 102 such that the rear image 300 outputted from the first camera 141 is displayed on the screen of the AVN 210.

Also, when the lane departure sensing unit 250 senses the lane departure without the direction indicating signal of the direction indicating unit 240, for example, when a vehicle 200 moves to the left direction and the lane departure is sensed, the controller 110 outputs a switching signal such that the second camera 142 and the AVN 210 are connected, and outputs a reverse gear signal to the AVN 210 through the AVN connection line 102 such that a left image 310 outputted from the second camera 142 is displayed through the screen of the AVN 210.

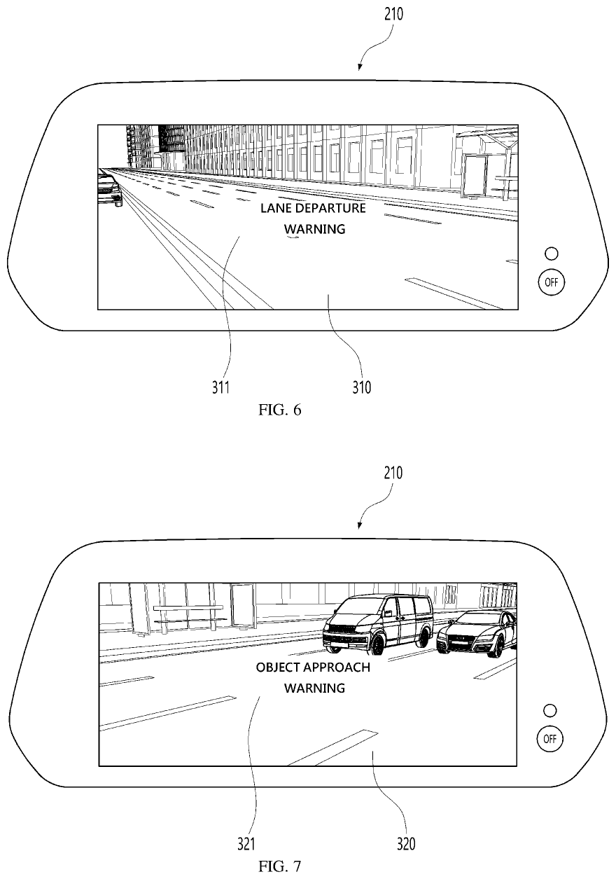

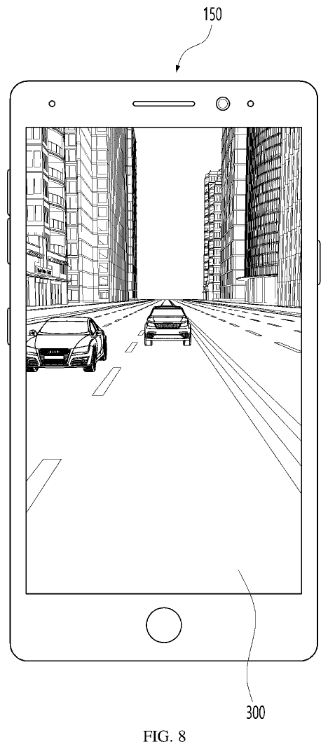

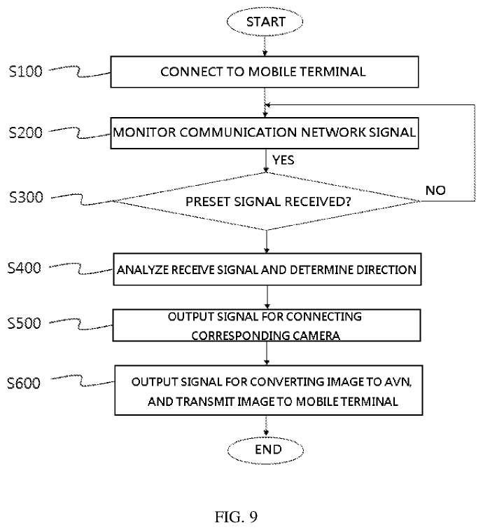

Also, when the event signal detected through monitoring is, for example, a lane departure sensing signal, the controller 110 may output a warning message 311 including text information such as a “lane departure warning” on the left image 310 outputted from the second camera 142 as shown in FIG. 6, or may output a warning sound or a warning image through AVN 210 in addition to the warning message 311.

Also, when the event signal detected through monitoring is, for example, a direction indicating signal, the controller 110 may output a warning message 321 including text information such as a “object approach warning” on the right image 320 outputted from the third camera 143 as shown in FIG. 7, or may output a warning sound or a warning image through the AVN 210 in addition to the warning message 321.

Also, the reverse gear signal outputted from the controller 110 is configured to be outputted only to the AVN 210 through the AVN connection line 102 so as to operate regardless of the driving state of a vehicle.

Also, when a vehicle 200 is started or a boarding signal is inputted to a vehicle 200, the controller 110 may be connected to a driver or passenger's mobile terminal 150 through a pairing or certain authentication process. The image outputted to the AVN 210 may be transmitted to the mobile terminal 150 through the image compression unit 120.

The image compression unit 120 may be connected to the mobile terminal 150 through a mobile communication network such as Bluetooth, Wi-Fi, LTE, and 5G.

Also, when the application program installed in the mobile terminal 150 is executed, the image compression unit 120 is turned on to compress an image outputted from at least one of the first to third cameras 141, 142 and 143 connected through the switch unit 130 using an image compression program, and then transmits the compressed image to the mobile terminal 150.

That is, the image compression unit 120 is turned on/off according to whether the application program of the mobile terminal 150 is executed, and transmits the compressed image to the mobile terminal 150 when the application program is running.

Also, the image compression unit 120 transmits the compressed image to the mobile terminal 150 using at least one mobile communication network of Bluetooth, Wi-Fi, LTE and 5G, and transmits the compressed image using a mobile communication network that maintains an optimal connection state.

For example, when connection using Wi-Fi it is impossible, the compressed image may be transmitted using LTE, 5G, or the like.

Also, the image compression unit 120 may transmit the position information of the camera together with the transmitted image.

The switch unit 130 is configured to control at least one of the first to third cameras 141, 142 and 143 to be connected to the AVN 210, and is turned on/off according to a switching signal outputted from the controller 110 to allow at least one of the first to third cameras 141, 142 and 143 to be connected to the AVN 210 such that an image photographed by the camera is outputted through the screen of the AVN 210.

The first to third cameras 141, 142 and 143 are installed at the rear side, left side mirror, and right side mirror of a vehicle 200 to photograph the rear side and left/right sides of a vehicle 200, respectively.

Also, the first to third cameras 141, 142 and 143 may include a CCD sensor, a CMOS sensor, and the like, and all cameras including a sensor or an element that converts and outputs an optical signal into an electrical signal may be used.

Also, the first to third cameras 141, 142 and 143 may be a camera separately installed in a vehicle 200, but may also be a camera of a black box system installed in a vehicle 200.

That is, the camera may be configured with a camera installed in a two-channel black box system for photographing the front and rear sides of a vehicle or a camera installed in a four-channel black box system for photographing all of the front, rear, left, and right sides. The cameras of the black box system may be connected to the AVN 210 according to the switching signal of the switching unit 130.

Also, other signals such as a GPS signal received from the black box system or a shock sensing signal outputted from the black box system may be transmitted together with the camera image signal outputted to the AVN 210.

The mobile terminal 150 is configured to receive and display an image outputted through the AVN 210, and may be configured as a smartphone, a tablet PC, etc., but the present invention is not limited thereto. The mobile terminal 150 may include all terminals which can be installed with an application program and is capable of wireless communication using a wireless communication protocol (e.g., Bluetooth, Wi-Fi, LTE, 5G, etc.) of a certain format.

That is, when an application program is executed, the mobile terminal 150 may be connected to the image compression unit 120 through Wi-Fi Direct, and may receive an image through the Wi-Fi Direct.

Also, in case of failing to establish a direct connection through Wi-Fi or Bluetooth, an image signal transmitted from the image compression unit 120 may be received using a mobile communication network such as a 5G network.

Also, when the installed application program is executed, the mobile terminal 150 outputs an operation signal such that the image compression unit 120 is turned on, and when the execution of the application program ends, the mobile terminal 150 outputs an operation signal such that the image compression unit 120 is turned off.

Also, when receiving the image transmitted through the image compression unit 120, the mobile terminal 150 outputs the image to a top view screen 151 indicating the position of the side and rear of a vehicle where the event signal is generated, and to a display screen 152 indicating the received image.

Hereinafter, a method for displaying side and rear images of a vehicle according to an embodiment of the present invention will be described with reference to FIGS. 3, 4, and 9.

When a vehicle 200 is started or a boarding signal is inputted to a vehicle 200, a controller 110 performs a pairing or a certain authentication process with a driver or the passenger's mobile terminal 150, and an image compression unit 120 maintains connection state to the mobile terminal 150 (S100).

The controller 110 monitors a communication network 200a of a vehicle 200 connected through a network connection line 101 (S200).

In operation S200, the controller 110 checks whether or not the gear signal of the transmission 220 is a driving state of “D”, and monitors an event signal broadcasted through the communication network 200a (S300).

As a result of the monitoring in operation S300, when a preset event signal is detected, the controller 110 analyzes the event signal and checks whether the event signal is inputted from the sensing unit 230, the direction indicating unit 240, or the lane departure sensing unit 250 (S400).

That is, in operation S400, when the event signal is a sensing signal generated by sensing the approach of an object from the sensing unit 230, the controller 110 analyzes the approach direction of the object among the rear region A, left region B and right region C of a vehicle, and determines the approach direction of the object.

Also, in operation S400, when the analyzed event signal is a direction indicating signal generated from the direction indicating unit 240, the controller 110 analyzes the direction from which the direction indicating signal is outputted, and then determines whether the direction is the left region B or the right region C of a vehicle.

Also, in operation S400, when the analyzed event signal is a lane departure sensing signal generated from the lane departure sensing unit 250, the controller 110 analyzes the direction from which the direction indicating signal is outputted, and then determines whether the direction is the left region B or the right region C of a vehicle.

According to the analysis result of the operation S400, the controller 110 outputs, to the switching unit 130, a switching signal for connecting to the corresponding camera such that a photographed image of the camera installed in the analyzed direction among the first to third cameras 141, 142 and 143 installed in arbitrary positions of a vehicle 200 is outputted through the screen of the AVN 210 (S500).

After operation S500, the controller 110 outputs a reverse gear signal to the AVN 210 through the AVN connection line 102 such that an image outputted from at least one of the first to third cameras 141, 142 and 143 connected through the switch unit 130 can be displayed through the AVN 210 (S600).

Also, in operation S600, when the event signal analyzed in operation S400 is, for example, a lane departure sensing signal, the controller 110 may overlap text information such as a “lane departure warning” or an arbitrary warning image on the image outputted from the camera, or may additionally output warning sound information through the AVN 210.

Also, when the event signal is a direction indicating signal, the controller 110 may overlap text information such as an “object approach warning” or an arbitrary warning image on the image outputted from the camera, or may additionally output warning sound information through the AVN 210.

Meanwhile, in operation S600, when the switching signal of operation S500 is outputted, the image compression unit 120 may compress the image outputted from the camera through an image compression program, and then may transmit the compressed image to the mobile terminal 150 through Wi-Fi Direct or a mobile communication network.

Accordingly, an apparatus and method for displaying side and rear images of a vehicle according to an embodiment of the present invention can be installed so as to be connected to a communication network of vehicle electric parts, can monitor event signals generated during driving of a vehicle, and if a specific event signal is received, can control side and rear images of a vehicle photographed by cameras to be displayed through an AVN.

The technical spirit of the present invention has been described through several embodiments.

According to an embodiment of the present invention, the camera images can be displayed through the AVN of a vehicle when a certain condition is satisfied even if a vehicle in the original state is not supported. In particular, it is possible to secure safety by transmitting a certain signal through a line directly connected to the AVN and by fundamentally blocking the possibility of malfunction of other vehicle electric parts.

On the other hand, even when not supported in an original vehicle, a user can set the conditions (e.g., changing lanes without turning on the indicator light) for displaying the side and rear camera images through the AVN using a dedicated application on the smartphone.

Furthermore, the side and rear camera images can also be checked on the screen of the smartphone as well as the AVN while a vehicle's dedicated application is running.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. An apparatus for displaying side and rear view images of a vehicle, the apparatus comprising:
a network connection line connected to a communication network of a vehicle;
an Audio Video Navigation (AVN) for displaying an image thereon;
a controller coupled to the network connection line and configured to monitor the communication network to detect an event signal that is broadcasted to the communication network and configured to output, responsive to detecting the event signal, a switching signal to a switching unit;
an AVN connection line that directly connects the AVN to the controller; and
the switching unit connected to one or more cameras, and, upon receiving the switching signal from the controller, configured to connect one of the one or more cameras to the AVN so that an image from the camera connected to the AVN is sent to the AVN;
wherein, while the vehicle is moving forward and the event signal is detected, the controller is further configured to:
analyze the event signal to determine whether the event signal is inputted from left, right, or rear direction of the vehicle, wherein the camera connected to the AVN is in a direction from which the event signal is inputted; and
send a reverse gear signal to the AVN via the AVN connection line, wherein the reverse gear signal is same as a signal that is broadcasted to the communication network when a transmission of the vehicle is in a reverse state.

2. The apparatus of claim 1, wherein the event signal is one of a sensing signal of a sensing unit, a direction indicating signal of a direction indicating unit, and a lane departure sensing signal of a lane departure sensing unit, which are transmitted through the communication network.

3-4. (canceled)

5. The apparatus of claim 1, further comprising an image compression unit for compressing an output image of the camera connected to the AVN and transmitting the compressed output image to a mobile terminal connected by a wireless communication channel.

6. The apparatus of claim 1, wherein at least one of the one or more cameras is a camera of a black box provided in the vehicle, and
the controller processes information received from the black box and overlays the received information on the output image of the camera connected to the AVN.

7. A method for displaying side and rear view images of a vehicle, the method comprising:
monitoring a communication network of a vehicle, via a network connection line connected to a communication network, during driving of the vehicle in a forward direction to detect a preset event signal that is broadcasted to the communication network;
analyzing the preset event signal to determine whether the preset event signal is inputted from left, right, or rear direction of the vehicle;
according to the determined direction from which the preset event signal is inputted, connecting one of one or more cameras to an Audio Video Navigation (AVN) of the vehicle; and
transmitting a reverse gear signal along a line that directly connects a controller of the vehicle to the AVN,
wherein the reverse gear signal is same as a signal that is broadcasted to the communication network as a transmission of the vehicle is in a reverse state.

8. The method of claim 7, further comprising:
compressing an image transmitted from the camera connected to the AVN; and
transmitting the compressed image to a mobile terminal by a wireless communication channel.
